(19) United States
(12) Patent Application Publication
(10) Pub. No.: US 2002/0166377 A1
(43) Pub. Date: Nov. 14, 2002

(54) Combination gas cap and LED fuel gauge

(76) Inventors: Joseph Baron, Huntington Beach, CA (US); Li Qun Yang, Hangzhou (CN)

Correspondence Address: LAW OFFICES OF ERIC KARICH, 2807 ST. MARK DR., MANSFIELD, TX, 76063, US

(21) Appl. No.: 09/854,055

(22) Filed: May 12, 2001

(51) Int. Cl. G01F 23/00

(52) U.S. Cl. 73/290 R

(57) ABSTRACT

A combination gas cap and LED fuel gauge, adapted for sealing a gas tank filling aperture of a gas tank of a motorcycle, has a plurality of LEDs for displaying the measurements of a gas level measuring device installed in or on the gas tank. The combination includes a gas cap housing and an LED control module. The gas cap housing is adapted for fitting within and sealing the gas tank filling aperture, as well as containing the LED control module. The LED control module includes and controls the plurality of LEDs that provide a visual indicator as to how much gas is in the gas tank. The gas cap housing has a top surface and a base. The top surface has a perimeter, and a perimeter sidewall extends downwardly from the perimeter of the top surface. The perimeter sidewall has an indicator opening through which the plurality of LEDs can be viewed. The base has an electronics containment cavity for containing, positioning, and protecting the LED control module, and also has a locking portion adapted to lockingly engage the gas tank filling aperture, thereby positioning the plurality of LEDs adjacent the outer surface of the gas tank.

### CROSS-REFERENCE TO RELATED APPLICATIONS

This application for a utility patent claims the benefit of Chinese Patent Registration No. ZL 00 2 08692.1, titled “Gas Cap that Tells the Gasoline Level of Motorcycle,” filed May 12, 2001.

### STATEMENT REGARDING FEDERALLY SPONSORED RESEARCH

>Not Applicable.

### BACKGROUND OF THE INVENTION

1. Field of the Invention

This invention relates generally to gas caps, and more particularly to a gas cap that includes a plurality of LEDs to indicate the amount of gas remaining in a gas tank.

1. Description of Related Art

Gas caps, designed to seal a the gas tank filling aperture of a gas tank of a motorcycle, are well know in the art. Fuel level gauges, designed to inform a user how much gas is left in the gas tank, are also well known. It is also known to position a fuel level gauge within a gas cap.

There are many problems with prior art gas caps, however, that have attempted to integrate a fuel level gauge within a gas cap. Fuel level gauges used in motorcycles have predominantly used a needle to indicate the fuel level within the gas tank. The needle type of fuel level gauge is difficult to read while riding the motorcycle due to glare on the face of the gauge, vibrations, fog accumulating on the face of the gauge, and other practical difficulties.

The prior art teaches the inclusion of a needle type fuel level gauge in a gas cap. However, the prior art does not teach the use of a plurality of LEDs to indicate the amount of gas remaining in a gas tank. The prior art particularly does not teach the use of a plurality of LEDs positioned on the side of the gas cap, where the plurality of LEDs will not glare into the eyes of the user while the user is driving the motorcycle at night, and where the plurality of LEDs project light onto an outer surface of the gas tank, thereby facilitating observing the plurality of LEDs. The present invention fulfills these needs and provides further related advantages as described in the following summary.

### SUMMARY OF THE INVENTION

The present invention teaches certain benefits in construction and use which give rise to the objectives described below.

The present invention provides a combination gas cap and LED fuel gauge. The combination is adapted for sealing a gas tank filling aperture of a gas tank of a motorcycle and for displaying, with a plurality of LEDs, the measurements of a gas level measuring device installed in or on the gas tank. The combination includes a gas cap housing and an LED control module. The gas cap housing is adapted for fitting within and sealing the gas tank filling aperture, as well as containing the LED control module. The LED control module includes and controls the plurality of LEDs that provide a visual indicator as to how much gas is in the gas tank. The gas cap housing has a top surface and a base. The top surface has a perimeter, and a perimeter sidewall extends downwardly from the perimeter of the top surface. The perimeter sidewall has an indicator opening through which the plurality of LEDs can be viewed. The base has an electronics containment cavity for containing, positioning, and protecting the LED control module. The base preferably includes a locking portion adapted to lockingly engage the gas tank filling aperture, thereby positioning the plurality of LEDs adjacent the outer surface of the gas tank.

A primary objective of the present invention is to provide a combination gas cap and LED fuel gauge, the combination having advantages not taught by the prior art.

Another objective is to provide an LED fuel gauge that can be mounted upon a gas tank of a motorcycle, the LED fuel gauge being structured so that it does not glare into the eyes of a user when the user is driving the motorcycle.

A further objective is to provide an LED fuel gauge that can be easily read by the user while he or she is driving the motorcycle.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a perspective view of the preferred embodiment of the present invention;

FIG. 2 is a bottom plan view thereof;

FIG. 3 is an exploded perspective view thereof;

FIG. 4 is a perspective view of the combination once it has been removed from the gas tank filling aperture of the gas tank; and

FIG. 5 is a block diagram illustrating the connection between the plurality of LEDs and the gas level measuring device.

### DETAILED DESCRIPTION OF THE INVENTION

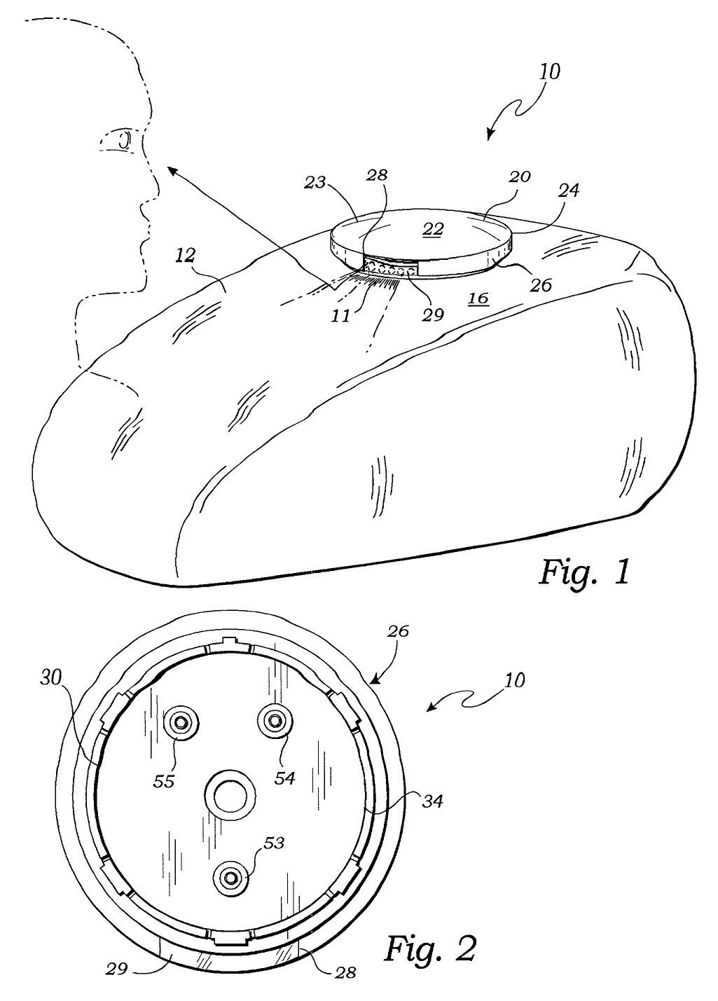

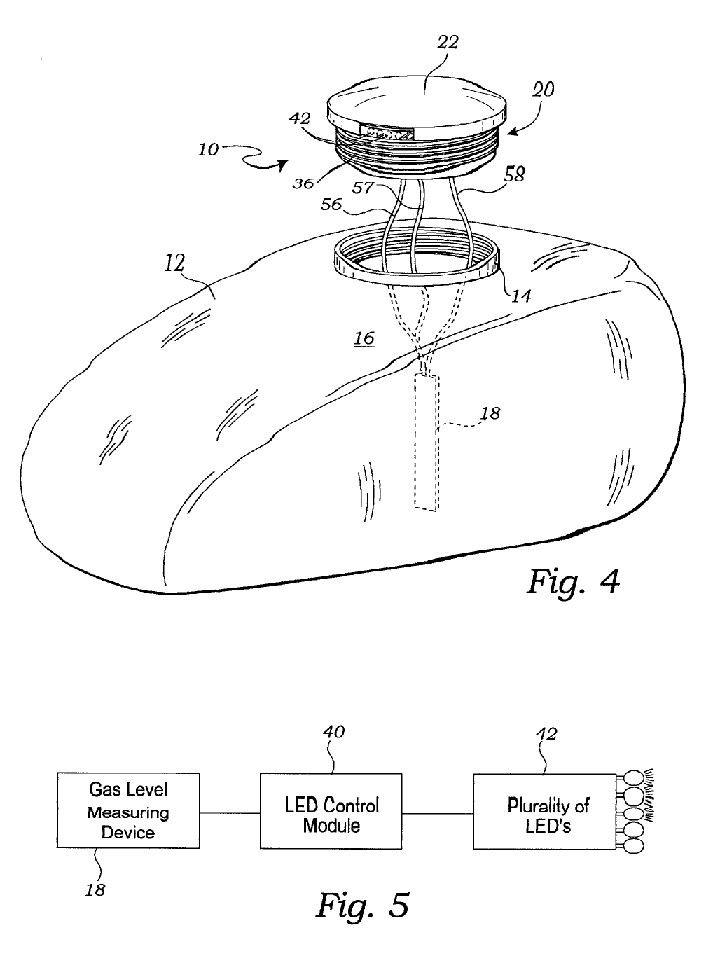

The above described drawing figures illustrate the invention, a combination gas cap and LED fuel gauge 10. As shown in FIGS. 1 and 4, the combination 10 is adapted for sealing a gas tank filling aperture 14 of a gas tank 12 of a motorcycle and for displaying, with a plurality of LEDs 42, the measurements of a gas level measuring device 18 installed in or on the gas tank 12. As shown in FIG. 1, the novel placement of the plurality of LEDs 42, on the side of the combination 10, enables a user to see a reflection 11 of the plurality of LEDs 42 on an outer surface 16 of the gas tank 12 of the motorcycle.

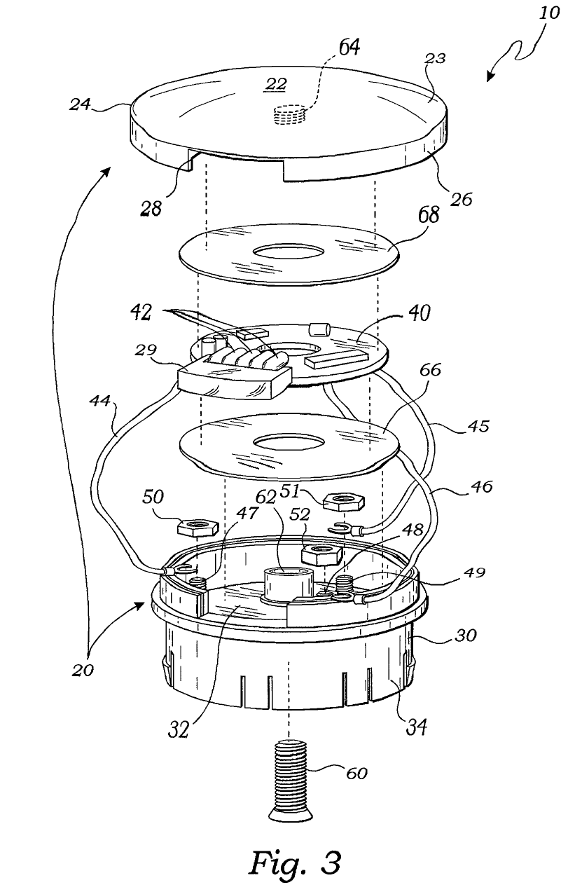

As shown in FIG. 3, the combination 10 includes a gas cap housing 20 and an LED control module 40. The gas cap housing 20 is adapted for fitting within and sealing the gas tank filling aperture 14, as well as containing the LED control module 40. The LED control module 40 includes and controls the plurality of LEDs 42 that provide a visual indicator as to how much gas is in the gas tank 12.

The gas cap housing 20 has a top surface 22 and a base 30. In the preferred embodiment, the top surface 22 is formed by a top portion 23 that is separable from the base 30, although in alternative embodiments the top surface 22 might be integrally formed by the base 30. The top surface 22 has a perimeter 24, and a perimeter sidewall 26 extends downwardly from the perimeter 24 of the top surface 22. The perimeter sidewall 26 has an indicator opening 28 through which the plurality of LEDs 42 can be viewed. The top portion 23 is preferably constructed of chrome or chrome plated plastic or steel so that it provides an attractive exterior for the combination 10.

As shown in FIG. 3, the base 30 has an electronics containment cavity 32 for containing, positioning, and protecting the LED control module 40. The base 30 preferably includes a locking portion 34 adapted to lockingly engage the gas tank filling aperture 14, thereby positioning the plurality of LEDs 42 adjacent the outer surface 16 of the gas tank 12. The base 30 is preferably constructed of molded plastic or similar material. The locking portion 34 is preferably adapted to be attached to a threaded component 36, or a similarly component, shaped to removably engage the base 30 to the gas tank filling aperture 14 of the gas tank 12.

As shown in FIGS. 3 and 5, the LED control module 40 mounts the plurality of LEDs 42 and functions to operably control which of the plurality of LEDs 42 is illuminated, such that the gas level measuring device 18 operably controls which of the plurality of LEDs 42 are illuminated. As shown in FIG. 3, the LED control module 40 is preferably a printed circuit board such as can be designed by those skilled in the art. The LED control module 40 is preferably operable connected to first, second, and third connector wires 44, 45, and 46, which are clamped to first, second, and third electrically conductive bolts 47, 48, and 49, respectively, with first, second, and third locking nuts 50, 51, and 52, respectively. The first, second, and third electrically conductive bolts 47, 48, and 49 and the first, second, and third locking nuts 50, 51, and 52 together clamp the base 30 so that the first, second, and third connector wires 44, 45, and 46 lock the LED control module 40 to the base 30.

As shown in FIG. 2, the first, second, and third electrically conductive bolts 47, 48, and 49, present first, second, and third terminal heads 53, 54, and 55 outside of the electronics containment cavity 32, thereby enabling first, second, and third control wires 56, 57, and 58 to be attached to the first, second, and third terminal heads 53, 54, and 55.

As shown in FIG. 4, when the combination 10 is removed from the gas tank filling aperture 14, the first, second, and third control wires 56, 57, and 58 mechanically stress the first, second, and third terminal heads 53, 54, and 55, which are firmly anchored to the base 30. This arrangement enables the gas level measuring device 18 to be operably attached to the LED control module 40 without subjecting the LED control module 40 to mechanical stress.

The LED control module 40 is positioned within the electronics containment cavity 32 so that the plurality of LEDs 42 are operably positioned adjacent the indicator opening 28. In the preferred embodiment, as shown in FIG. 3, the combination 10 includes first and second insulating disks 66 and 68, one on either side of the LED control module 40, to protect the LED control module 40 from electrical or mechanical damage. The first and second insulating disks 66 and 68 are preferably made of paper, although rubber, plastic, or similar material can also be used. The LED control module 40 is preferably also covered with a sealant (not shown) to protect the delicate electronics from moisture. The entire combination 10 is then fastened together with a locking screw 60 that fits through a central bore 62 of the base 30, through the LED control module 40 and the first and second insulating disks 66 and 68, and threadedly engages an internally threaded receiving bore 64 of the top portion 23.

As shown in FIG. 1, the plurality of LEDs 42 are preferably positioned beneath the top surface 22 of the gas cap housing 20. By positioning the plurality of LEDs 42 beneath the top surface 22, the top surface 22 functions to shield the plurality of LEDs 42 from glaring into the eyes of the user when the user is driving the motorcycle at night. By placing of the plurality of LEDs 42 on the side of the combination 10, the user is able to see the reflection 11 of the plurality of LEDs 42 on an outer surface 16 of the gas tank 12 of the motorcycle, as described above.

As shown in FIG. 3, the combination 10 preferably further includes a translucent LED cover 29 that is shaped to fit within the indicator opening 28 and around the plurality of LEDs 42. The translucent LED cover 29 is preferably made of a durable, shatter-proof plastic that protects the plurality of LEDs 42 from damage. As shown in FIG. 1, the translucent LED cover 29 also functions to facilitate the user's viewing of the plurality of LEDs 42 by scattering the light emitted by the plurality of LEDs 42.

The invention includes a method for measuring a volume of gasoline in a gas tank 12 of a motorcycle using the combination 10 described above. As shown in FIG. 3, the LED control module 40 is positioned within the electronics containment cavity 32 so that the plurality of LEDs 42 are operably positioned adjacent the indicator opening 28. In the preferred embodiment, the first and second insulating disks 66 and 68 are positioned on either side of the LED control module 40 to protect it from damage. The translucent LED cover 29 is positioned within the indicator opening 28 and around the plurality of LEDs 42 to protect the plurality of LEDs 42 from damage. The locking screw 60 is positioned through the central bore 62 of the base 30, the LED control module 40, and the first and second insulating disks 66 and 68, and threadedly engaged with the internally threaded receiving bore 64 of the top portion 23 to lock the combination 10 together.

The LED control module 40 is then connected to the gas level measuring device 18 such that the gas level measuring device 18 operably controls which of the plurality of LEDs 42 are illuminated. As shown in FIG. 4, the gas level measuring device 18 is operably positioned in or on the gas tank 12. The first, second, and third control wires 56, 57, and 58 are then used to connect the gas level measuring device 18 to the first, second, and third terminal heads 53, 54, and 55, respectively. Finally, the combination 10 is positioned within the gas tank filling aperture 14 to seal the gas tank filling aperture 14, as shown in FIG. 1.

Once assembled and positioned on the gas tank 12, the combination 10 functions such that the gas level measuring device 18 operably controls which of the plurality of LEDs 42 are illuminated. In the preferred embodiment, one of the plurality of LEDs 42 is red, and the remainder of the plurality of LEDs 42 are green, although other color schemes can be used. For example, a yellow LED might be included as an early warning before red. In another example, entirely arbitrary colors might be selected, although the arbitrary colors might be confusing to the user, so their use is not preferred.

In the preferred embodiment, all of the green LEDs are illuminated when the gas tank 12 is fill of gas. As the gas level drops, the green LEDs turn off one by one until only one green LED is left. The user is able to quickly estimate the amount of gas remaining by the size of the reflection 11. Finally, when the tank is nearing empty, the red LED is illuminated. The red LED causes the reflection 11 to turn red, alerting the user that it is time to purchase more gas. It is possible that the red LED flashes when the gas tank 12 is very nearly empty, as a final warning that the gas tank 12 is very nearly empty.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A combination gas cap and LED fuel gauge, the combination being adapted for sealing a gas tank filling aperture of a gas tank of a motorcycle and for displaying the measurements of a gas level measuring device installed in or on the gas tank, the gas tank having an outer surface, the combination comprising:
a gas cap housing having a top surface and a base, the top surface having a perimeter, and the base having an electronics containment cavity;
a perimeter sidewall extending downwardly from the perimeter of the top surface, the perimeter sidewall having an indicator opening; and
an LED control module having a plurality of LEDs, the LED control module being adapted to operably connect to the gas level measuring device such that the gas level measuring device operably controls which of the plurality of LEDs are illuminated, the LED control module being positioned within the electronics containment cavity so that the plurality of LEDs are operably positioned adjacent the indicator opening.

2. The combination of claim 1 wherein the base includes a locking portion adapted to lockingly engage the gas tank filling aperture, thereby positioning the plurality of LEDs adjacent the outer surface of the gas tank.

3. The combination of claim 1 wherein the plurality of LEDs are positioned beneath the top surface of the gas cap housing.

4. The combination of claim 1 further comprising a translucent LED cover, the translucent LED cover being shaped to fit within the indicator opening and around the plurality of LEDs.

5. A method for measuring a volume of gasoline in a gas tank of a motorcycle, the method comprising the steps of:
a) providing a combination gas cap and LED fuel gauge, the combination having
a gas cap housing having a top surface and a base, the top surface having a perimeter, and the base having an electronics containment cavity;
a perimeter sidewall extending downwardly from the perimeter of the top surface, the perimeter sidewall having an indicator opening; and
an LED control module having a plurality of LEDs;
b) providing a motorcycle having a gas tank, the gas tank having a gas level measuring device, an outer surface, and a gas tank filling aperture;
c) positioning the LED control module within the electronics containment cavity so that the plurality of LEDs are operably positioned adjacent the indicator opening;
d) connecting the LED control module to the gas level measuring device such that the gas level measuring device operably controls which of the plurality of LEDs are illuminated; and
e) positioning the combination to seal the gas tank filling aperture such that the plurality of LEDs project a reflection upon the outer surface of the gas tank.
